(19) United States
(12) Patent Application Publication
(10) Pub. No.: US 2020/0344046 A1
(43) Pub. Date: Oct. 29, 2020

(54) Product Tracking System and Method

(71) Applicant: Tom Lindeman, Kirkland, WA (US)

(72) Inventor: Tom Lindeman, Kirkland, WA (US)

(21) Appl. No.: 16/858,420

(22) Filed: Apr. 24, 2020

Related U.S. Application Data
(60) Provisional application No. 62/838,085, filed on Apr. 24, 2019.

(51) Int. Cl. H04L 9/06; H04L 9/08; G06K 7/14; G06Q 20/32; G06Q 10/08

(52) U.S. Cl. CPC H04L 9/0643; H04L 9/0825; H04L 2209/38; G06Q 20/3276; G06Q 10/0833; G06K 7/1417

(57) ABSTRACT

A product tracking and authentication method and system using the cryptographic security of the blockchain, smart contracts, and information sent from scanned encrypted QR codes assigned to the product. Each product is registered and labeled with a unique QR code created by the HazeChain server. A private key and a public key are generated for each product. The QR code is embedded with a public key specific to a product. When the product moves in a supply chain it is scanned by various actors. The scanned data and the time, date and location data are sent to the server automatically and verified. The scanned data is added to an Ethereum smart contract and added to the blockchain for permanent immutable storage. Product seller and customers are now guaranteed to be presented with date that matches the exact product in their hand.

This utility patent application is based on and claims the filing date benefit of U.S. provisional patent application (Application No. 62/838,085) filed on Apr. 24, 2019.

### COPYRIGHT NOTICE

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

### 1. Field of the Invention

This invention relates supply chain security and product tracking methods and systems, and more specifically to such methods and systems that use blockchains

### 2. Description of the Related Art

During the Covid-19 virus pandemic, medical supplies, such as masks, personal protection equipment and medical test kits have been in high demand. Shortages of these supplies have occurred and the prices for supplies have increased. These conditions lead to situations where shipments of these medical supplies may be intercepted, stolen, altered, or swapped out with counterfeit supplies. Secure product tracking systems are needed that ensure the medical supplies received by a buyer are the same medical supplies sent from the medical manufacturer or supplier.

In many states where cannabis is legal, state regulations requires producers to track the supply chain of cannabis products from seed to sale. Unfortunately, methods and systems used today, tracking can be faked, data can be altered, and the authenticity of the cannabis product is not guaranteed.

One common tool used with products today are the use of QR codes associated or linked to a website or file. Customers or middleman can scan the QR codes to learn about the product, its source and other information. Unfortunately, QR codes can also be altered.

Traditional use of QR codes on products labels has used them as communication links that a user scans with mobile phone that connects them to a website that provides more information about the product or the seller. Typically, the only information conveyed in an QR code is the website's URL, such as www.amazon.com. Unfortunately, QR codes can be copied and placed on counterfeit products. To prevent, counterfeiting use of QR codes it is possible to store other information in the QR code, such as a cryptographic key so that when the QR code is scanned by a QR code reader application, the server validates the integrity and origin of the QR code.

What is needed is a secured tracking system and method for products that uses unique QR codes assigned to each product which allows the QR codes to be encrypted with an encrypted key and with time, date, location and user identity data at selected stages of the distribution chain that become permanently associated with the product and cannot be tampered

### SUMMARY OF THE INVENTION

A secure product tracking and authentication method and system is disclosed herein that uses the combination of a QR code and the immutable cryptographic security of a blockchain.

The system includes a HazeChain server linked to a product database configured to store specific product data file for a product. A unique QR code is created by a QR code generating software program and assigned to each product in the product database. A key generator software program then creates a pair of cryptographic keys, a public key, and a public key, for each product. The public key is then added to the QR code. The private key is added to the product data file for the product on the HazeChain server.

The data in the product database and the QR code are then encrypted an added to an Ethereum smart contract. The Ethereum smart contact is then broadcast to the public Ethereum blockchain for permanent and tamper-resistant storage. The QR code is then printed on the product or on a label attached to the product.

During shipment from the manufacturer to a seller or the customer, various intermediate parties, called actors, may have to show receipt thereof, handle or interact with the product. Each actor uses a QR code scanning device, such as a smartphone with a QR code reader application installed. The scanned data from the QR code includes the time, date, and GPS location stamp are then sent to the server. A user's identity and log in information may also be requested from the server when the QR code data is sent for added security. An authentical software program on the server then checks for the public key signature in the QR code for that product. During the authentication step, the private key on the product data file on server is checked with the transmitted public key information. If the keys match, the data is deemed authentic and the data from the scanning device is added to the server database and added to an additional smart contract and written to the public blockchain.

At any time, the smart contract can be queried to view the validated tracking data form the QR code scans. The Ethereum blockchain is an open source repositories that can be queried by Etherscan or other blockchain data managers.

When a product moves through a supply chain it is scanned and time, date and location stamped is created which is written to an immutable ledger on the Ethereum blockchain.

By using uniquely generated QR codes with encrypted embedded data, the exact product in a consumer's hand is authenticated and validated as a match in the system. Further, by writing this tracking data to a secure and immutable blockchain and mapping it back to the specific product, there is a cryptographic guarantee that the data cannot be altered or deleted and is also transparent to members of a particular supply chain. This system therefore also allows the consumer to read information and provide feedback or reviews of the specific verified product they hold in their hand rather than a generic product name or potentially different product all together.

### DESCRIPTION OF THE DRAWINGS

FIG. 1 is an illustration of an exemplary supply chain distribution system for a product between a product manufacturer, two intermediate actors, and a product seller and customer

FIG. 2 is an illustration showing product data being sent to the server.

FIG. 3 is an illustration of a QR code generated for a product.

FIG. 4 is an illustration shown a pair of keys, a public key and a private key being associated with the QR code.

FIG. 5 is an illustration showing the public key being added to the smart contract and then broadcast an Ethereum blockchain.

FIG. 6 is an illustration showing labels with the QR code printed thereon being attached to the products.

FIG. 7 is an illustration showing a scanning device being used to scan the QR code on a product.

FIG. 8 is an illustration showing the scanned data from the scanning device being added to the records on the blockchain.

FIG. 9 is an illustration showing verification of the data being returned.

### DESCRIPTION OF THE PREFERRED EMBODIMENT(S)

Referring to the accompanying Figs. there is shown a product tracking method and system in which a product made by a manufacturer is shipped in a distribution system via one or more intermediate entities, called actors, and then to a seller or to a customer.

When a product moves in a supply chain it is scanned and time, date and location data is gathered via QR code scan which is written to an immutable ledger on the Ethereum blockchain.

By using uniquely generated QR codes with encrypted embedded data, the exact product in a consumer's hand is authenticated and validated as being a match in the system. Further, by writing this tracking data to a secure and immutable blockchain and mapping it back to the specific product, there is a cryptographic guarantee that the data cannot be altered or deleted, the product or label has not been replaced by a counterfeit product, and is also completely transparent to members of a particular supply chain. This system therefore also allows the consumer to read and provide reviews of the specific verified product that they hold in their hand rather than a generic product name or potentially different product all together.

The system includes the following components:
a HaseChain server; coupled to link to the world wide web;
a Product database configured to store product data, QR codes, and private key;
a QR code generating software program configured to create a unique QR code for each product;
a smart contract generator;
remote scanning devices that provide time, date and location data and configured to transmit data to the HaseChain server.

The system 8 includes a HazeChain server 10 linked to a product database 12 configured to store specific product data file for a product 5. A unique QR code 20 is created by a QR code generating software program 22 and assigned to each product in the product database 12.

A key generator software program 30 then creates a pair of cryptographic keys, a public key 32, and a public key 34, for each product 5. The public key 32 is then added to the QR code 20. The private key 34 is added to the product data file for the product on the product database 12 on the HazeChain server 10.

The data in the product database 12 for the product 5 and the QR code 20 are then encrypted an added to an Ethereum smart contract 40. The Ethereum smart contact 40 is then broadcast to the public Ethereum blockchain 50 for permanent and tamper-resistant storage. The QR code 20 is then printed on the product 5 or on a label 6 attached to the product 5.

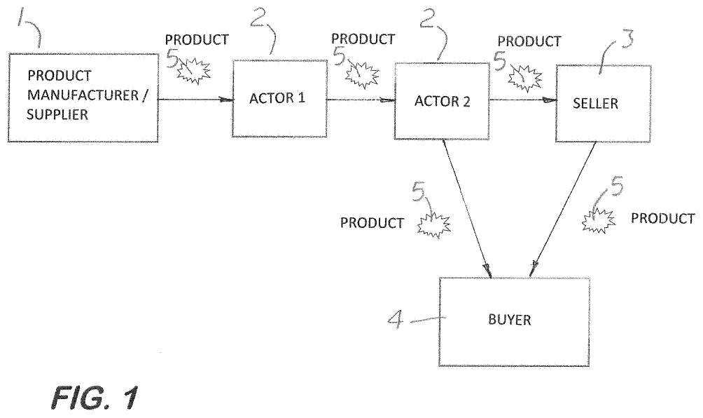

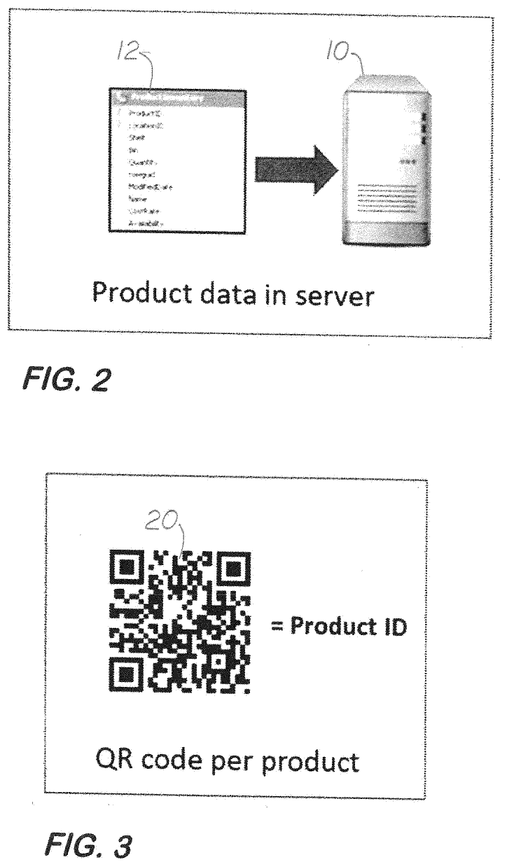

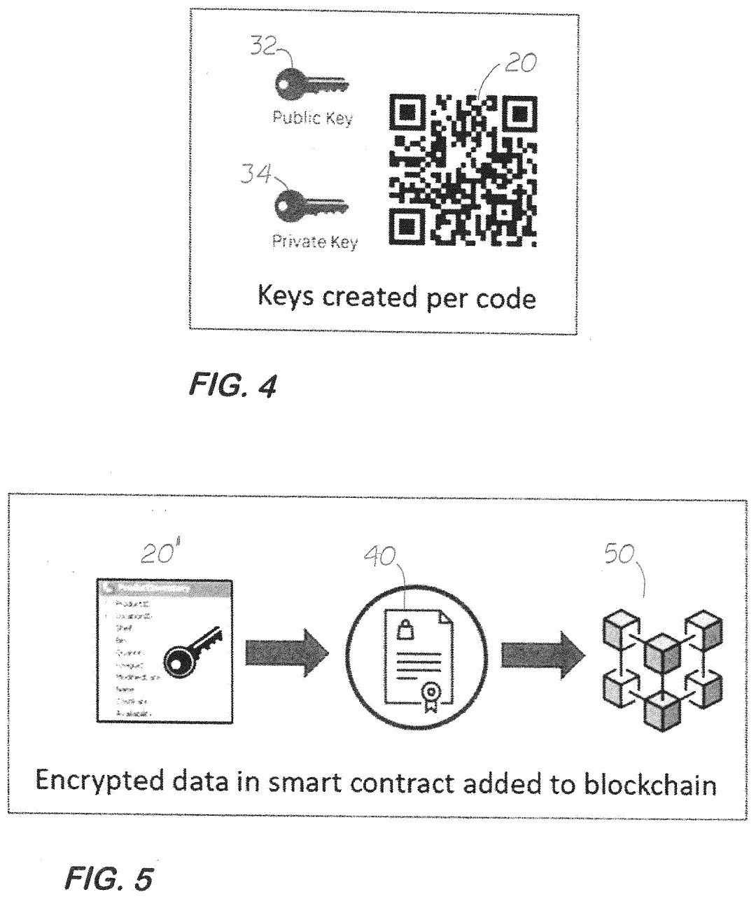

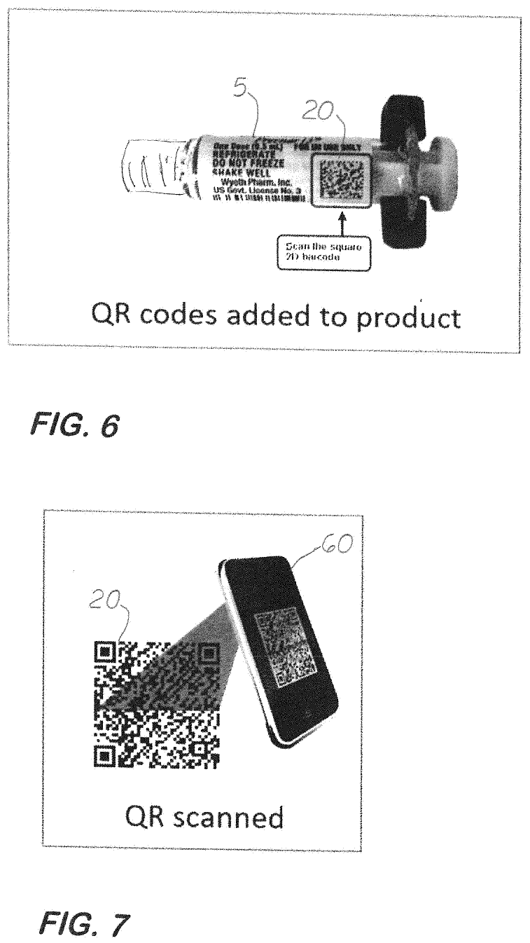

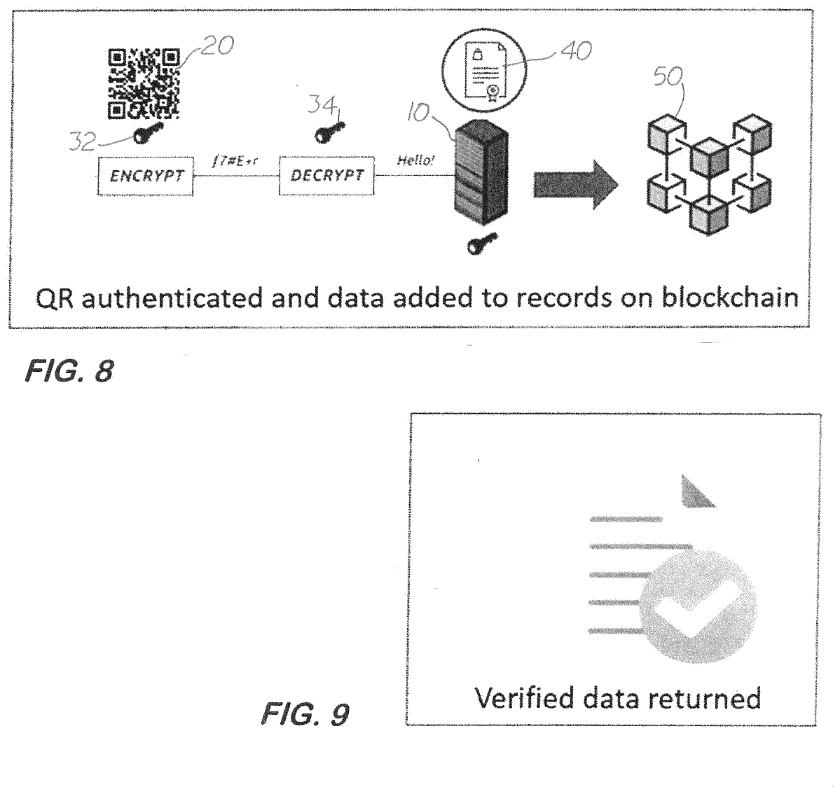

As shown in FIG. 1, during shipment from the manufacturer 1 to a seller 3 or the customer 4, various intermediate parties, called actors 2, may have to show receipt thereof, handle or interact with the product 5. Each actor 2 uses a QR code scanning device, such as a smartphone 60 with a QR code reader application 62 installed. The scanned data 61 from the QR code 20 includes the time, date, and GPS location stamp 65 are then sent to the HaseChain server 10. A user's identity and log in information 68 may also be requested from the Hasechain server 10 when the scanned QR code data 61 is sent for added security. An authentical software program 11 on the Hasechain server 10 hen checks for the public key signature 32 in the QR code 61 for that product 5. During the authentication step, the private key 34 on the product data file in the product database 12 on the HaseChain server 10 is checked with the transmitted public key 32 information. If the keys 32, 34 match, the data is deemed authentic and the data from the scanning device 60 is added to the server database and added to an additional smart contract 40 and written to the public blockchain 50.

At any time, the smart contract can be queried to view the validated tracking data form the QR code scans. The Ethereum blockchain is an open source repositories that can be queried by Etherscan or other blockchain data managers.

When a product 5 moves through a supply chain it is scanned and a time, date and location stamp is created which is written to an immutable ledger on the Ethereum blockchain. 50

Key features of the system are: a unique QR code 20 is created for a specific product 5 in the database; the creation and use of a public/private cryptographic key pair for each product that is stored in the product database file; data is sent to the HazeChain server 10 which authenticates the QR code 20 and product, and writes all data received from a remote scanning device to a smart contract 40 on the Ethereum blockchain 50. This data is now permanent and cannot be altered ever.

Using the system 10, tracking and traceability requirements and reports for compliance with state, federal and international laws are easily generated. Also, consumers can also scan the QR code 20 to retrieve information or provide reviews for the specific tracked product 5.

The system 10 includes a HazeChain server 10 which holds the product data and creates unique QR codes 20 and public private key pairs for each product. The QR code reader sends an encryption key along with GPS and time stamp data to the server 10 when scanned. Only the server 10 can decrypt and authenticate the embedded public key. The data is then written to an immutable ledger kept on a distributed blockchain for further viewing or analysis. Thus, the QR code 20 identifies the exact product being tracked.

During use, consumers may also scan the QR code 20 to view or provide more information.

In compliance with the statute, the invention described has been described in language specific as to structural features. It should be understood, however, that the invention is not limited to the specific features shown, since the means and construction shown comprises the preferred embodiments for putting the invention into effect. The invention is therefore claimed in its forms or modifications within the legitimate and valid scope of the amended claims, appropriately interpreted in accordance with under the doctrine of equivalents.

I claim:

1. A product tracking and authentication system, comprising;
a. a HazeChain server;
b. a QR code generating software program configured to produce a unique QR code for a product;
c. an encrypted private key generator associated with each unique QR code that produces a private key and a public key;
d. a product database containing an information about a product and encrypted QR code information and encrypted private key information;
e. a smart contract software program configured to broadcast the encrypted product data, QR code information and private key information to a blockchain.
f. at least one scanning device configured to scan a QR code to transmit the data from the QR code and public key to the HazeChain server along with time/date/and location information to the HazeChain server; and,
g. a verification software program used to verify information transmitted to said HazeChain server is matched to information in the product database; and
h. a blockchain access and management program configured to add smart contracts containing scanned data associated with the product to said blockchain.

2. A method for authenticating and determining alteration of a product is a distribution channel, the method comprises the steps of:
a. assigning a unique QR codes to a product;
b. encrypting the QR code with a private key;
c. recording the unique QR code and public key on a database associated with the product;
d. attaching or imprinting the QR code onto the product, or to a package containing the product, or to a label attached to the product or package.
e. using one or more scanning devices at different locations of the distribution channel, each scanning device configured to scan the QR code and generate a time/date/GPS location stamp that forms a unique hash; and
f. collecting the unique hash from each scanning device associated with the product to write to a blockchain.

3. The method as recited in claim 1, wherein the scanning device is a mobile phone.

4. The method as recited in claim 1, wherein the scanning device is configured to create a temperature stamp.
